(19) United States
(12) Patent Application Publication
(10) Pub. No.: US 2008/0074346 A1
(43) Pub. Date: Mar. 27, 2008

(54) Swept volume display

(76) Inventors: Erik Petrich, Norman, OK (US); Hakki H. Refai, Tulsa, OK (US); Monte P. Tull, Norman, OK (US); James J. Sluss, Broken Arrow, OK (US); Pramode Verma, Tulsa, OK (US)

Correspondence Address: DUNLAP CODDING & ROGERS, P.C., PO BOX 16370, OKLAHOMA CITY, OK, 73113, US

(21) Appl. No.: 11/528,306

(22) Filed: Sep. 27, 2006

(51) Int. Cl. G09G 3/00

(52) U.S. Cl. 345/30

(57) ABSTRACT

Volumetric three dimensional display that includes at least two image members. The image members are positioned such that each image member minimally blocks the view of light emitted from other image members providing a three dimensional image representation.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### REFERENCE TO A “SEQUENCE LISTING”, TABLE, OR COMPUTER PROGRAM LISTING APPENDIX SUBMITTED ON A COMPACT DISC AND AN INCORPORATION BY REFERENCE OF THE MATERIAL ON THE COMPACT DISC

Not applicable.

### BACKGROUND

A swept-volume display is a volumetric display in which a three-dimensional image is formed on a rapidly moving screen. Typical schemes use a screen rotating at about 600 revolutions per minute sweeping a spherical volume at each rotation, hence the technology's name. The screen itself is seen only as a blur due to retinal inertia, and the bright pixels projected on it form a three-dimensional picture. The formed image is inherently translucent, and such displays are usually enclosed in clear containers for safety reasons.

Generally, existing three-dimensional displays are limited to transparent images. Although this may be desirable in some applications, the transparency can be counterproductive in recognition of complex objects or the depiction of a photorealistic scene.

Some three-dimensional displays have overcome the transparency limitation by tracking the position of the viewer and dynamically adjusting the three-dimensional image so that only the surfaces visible from that position are generated in the display. In this case, however, the generated displays only correct for a single tracted viewer.

Ray tracing, a well-known discipline within the art of computer graphics, has been used for many years to generate highly realistic images of virtual 3-D objects. However, the final image created by ray tracing techniques is 2-D as the result of displaying the image on existing 2-D monitors or the printed page.

A variety of other arrangements have been proposed for moving a light element composed of a collection of directional lights, each pointing in a different direction in a swept volume display. However, problems still exist. For example, many of the prior embodiments are difficult to manufacture, provide for large wire bundles, and/or have unachievable rotational velocities.

It is, therefore, desirable to provide techniques capable of solving the various problems recited above in swept volume displays. It is to such a new and improved invention that the present embodiments are directed.

### SUMMARY OF THE EMBODIMENTS

The exemplary embodiments relate to a swept volume display. A swept volume display according to one exemplary embodiment for displaying an image comprises at least two image members. At least one of the image members has a directional light source. The directional light source comprises a directional emitter and a light source having a plurality of lights cooperating to direct light through the directional emitter. Additionally, the swept volume display comprises a movement device for sweeping the image members and an image controller for receiving a signal indicative of an image, storing the image, and providing signals to the image members.

In another exemplary embodiment, the swept volume display comprises an image generation device having a longitudinal axis. The image generation device comprises a plurality of image members directing light in at least one direction and at least one support having a first end and a second end. The first end is connected to the image members for stabilizing the image member. Additionally, the swept volume display comprises a movement device for sweeping the image members and an image controller for receiving a signal indicative of an image, storing the image, and providing signals to the image members.

The exemplary embodiments also include a method of making a swept volume display. The method comprises providing an image generation device connecting a movement device to the image generation device, and connecting an image controller to the image generation device such that the image controller communicates with the image generation device.

In another exemplary embodiment, the additional step of connecting a synchronization controller to the image controller and image generation device such that the synchronization controller communicates with the image generation device and the image controller is described.

The exemplary embodiments also include a method of using a swept volume display. The method of using comprises providing a swept volume display comprising at least two image members, a movement device, an image controller, and a power supply, supplying power to the swept volume display, and loading image data to the image controller.

Additional understanding of the invention can be obtained with review of the detailed description of exemplary embodiments, below, and the appended drawings illustrating exemplary embodiments.

### BRIEF DESCRIPTION OF THE SEVERAL VIEWS OF THE DRAWINGS

So that the above recited features and advantages can be understood in detail, a more particular description, briefly summarized above, may be had by reference to the embodiments thereof that are illustrated in the appended drawings. It is to be noted, however, that the appended drawings illustrate only typical embodiments and are therefore not to be considered limiting in scope, and may admit to other equally effective embodiments.

FIG. 1 is a side elevational diagrammatic view of one embodiment of a swept volume display.

FIG. 2 is a schematic perspective view of an image generation device of the swept volume display depicted in FIG. 1.

FIG. 3 is a diagrammatic view illustrating the location of a variety of image members mounted on a support, wherein the image members are positioned so that each image member will minimally block the view of light emitted from other image members.

FIG. 4 is a partial side elevational diagrammatic view of one embodiment of an image member.

FIG. 5 is a top plan view of the image member depicted in FIG. 4.

FIG. 6 is a partial side elevational view of one embodiment of image clusters forming part of the image member depicted in FIG. 4.

FIG. 7 is a top plan view of a hypothetical three-dimensional scene produced by the swept volume display depicted in FIG. 1.

### DETAILED DESCRIPTION

Embodiments are shown in the above-identified figures and described in detail below. In describing the embodiments, identical reference numerals are used to identify common or similar elements. The figures are not necessarily to scale. Certain features and certain views may be shown exaggerated in scale or in schematic or diagrammatic view in the interest of clarity and conciseness.

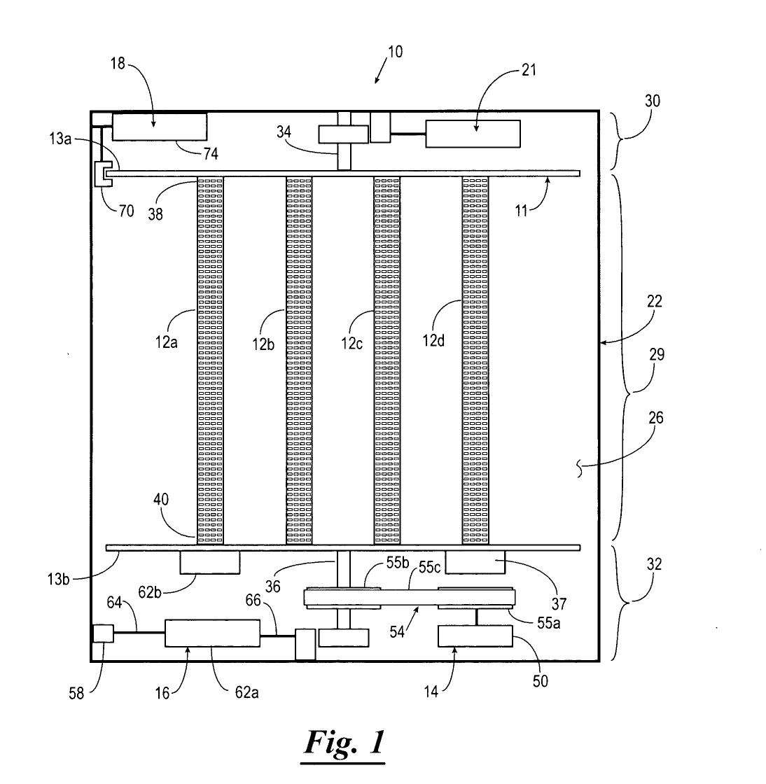

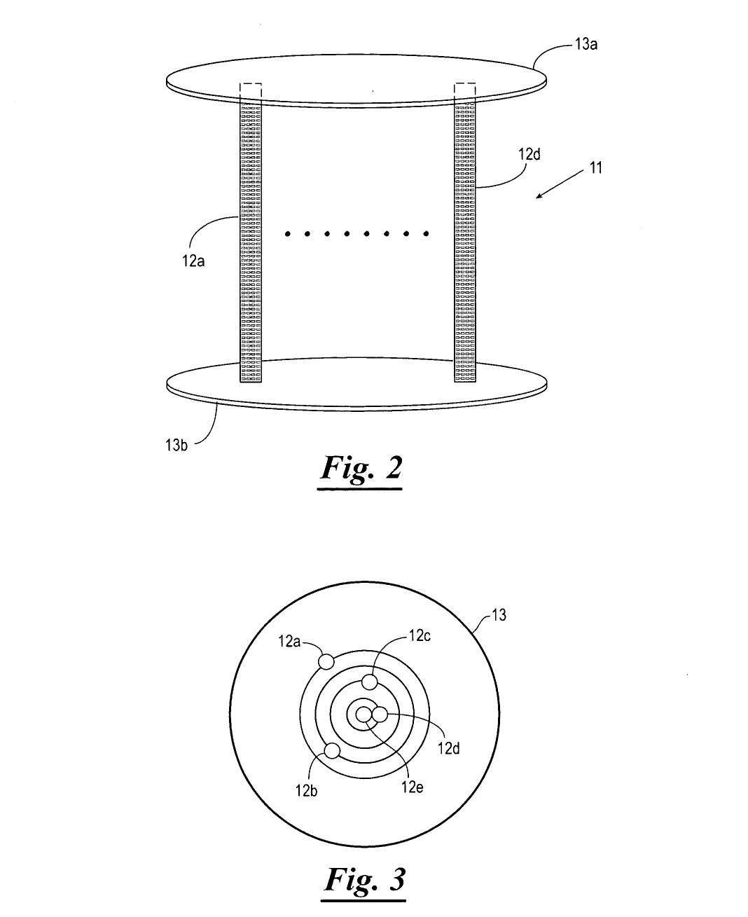

Referring now to the drawings, and in particular to FIG. 1 and FIG. 2, shown therein and designated by a reference numeral 10 is one embodiment of a swept volume display. The swept volume display 10 is a volumetric display in which a three-dimensional image is formed. In general, the swept volume display 10 is provided with at least one image generation device 11 comprising at least two image members 12 (labeled as 12a, 12b, 12c, 12d for purposes of clarity) and one or more supports 13 (labeled as 13a and 13b for purposes of clarity), a movement device 14, an image controller 16, a synchronization controller 18, and an optional enclosure 22.

In general, the enclosure 22 defines an internal space 26 in which the image is displayed. The image generation device 11, the movement device 14, the image controller 16, and the synchronization controller 18, are typically positioned within the internal space 26 of the enclosure 22 although the movement device 14, the image controller 16, and the synchronization controller 18 could be positioned outside of the internal space. It should be understood that at least a portion of the enclosure 22 is constructed of a transparent material forming a transparent area 29 so that a viewer located outside of the enclosure 22 can view the image within the enclosure 22. However, it should be understood that the amount and/or shape of the transparent material forming the enclosure 22 can be varied depending upon a number of factors, such as the desired optical effect, or the end use of the swept volume display 10.

The enclosure 22 can optionally be provided with opaque areas such as that indicated by the reference numerals 30 and 32 so as to hide various parts of the swept volume display 10 from the view of a viewer outside of the enclosure 22. For example, the movement device 14, synchronization controller 18, and supports 13 can be located adjacent to either the opaque area 30, or the opaque area 32 so as to hide the movement device 14, image controller 16, synchronization controller 18, and the supports 13 from the viewer.

The image generation device 11 is supported within the enclosure 22 so that the image generation device 11 can move to sweep the image members 12 about at least a portion of the volume within the enclosure 22. In one preferred embodiment, the swept volume display 10 is provided with a pair of rods 34 and 36 for supporting the image generation device 11 within the enclosure 22. In the example shown in FIG. 1, the rod 34 is positioned between the enclosure 22, and the support 13a, while the rod 36 is positioned between the enclosure 22 and the support 13b. The supporting of the image generation device 11 by way of the rods 34 and 36 permits the image generation device 11 to be rotated generally about its axis. However, it should be understood that the swept volume display 10 can be provided with other mechanisms for supporting the image generation device 11 such as bearings, magnets, tracks, or the like. Additionally, the use of counterweights 37 may be used to keep the image generation device 11 substantially stable within the enclosure 22.

It should further be understood that although the swept volume display 10 depicted in FIG. 1 is provided with two supports 13a and 13b, the swept volume display 10 could be provided with a single support 13. More than one support provides additional structural integrity to the image generation device 11, which is typically desirable. However, the enclosure 22 could be evacuated of all gaseous mediums, so as to provide a vacuum and in this instance, less support by way of the supports 13a, 13b, or a combination thereof would be acceptable.

As discussed above, the swept volume display 10 is provided with an image generation device 11 comprising at least two image members 12 and one or more supports 13. In FIG. 1, four of the image members 12 are depicted and designated by the reference numerals 12a, 12b, 12c, and 12d for purposes of clarity. Each of the image members 12 are connected to the supports 13 such that the image members 12 are held in position relative to the supports 13, and also relative to each other while the image generation device 11 is being moved or swept to form the image.

In one embodiment, each of the image members 12 are positioned in a parallel orientation with respect to the other image members 12, however, it should be understood that the image members 12 do not have to be positioned in parallel with the other image members 12. As depicted in FIG. 1, each of the image members 12 extends generally 90° away from each of the supports 13a and 13b. It should be understood that the angle from which the image members 12 extend from the supports 13 can be different than 90°.

Each of the image members 12 is provided with a first end 38, and a second end 40. The first end 38 of the image member 12 is connected to the support 13a, and the second end 40 of the image member 12 is connected to the support 13b.

As shown in FIG. 3, the image members 12 maintain a constant distance from the center of the support 13. The placement of each image member 12 is determined so as to minimally block the view of light emitted from other image members 12. For example, the embodiment in FIG. 3 demonstrates placement of five image members 12a, 12b, 12c, 12d, and 12e determined, for example, by a genetic algorithm so that placement minimally blocks the view of light emitted from each image member 12. Solutions to image member 12 placement are not necessarily unique and can vary as the number of image members 12 increases. Currently within the art, exact solutions appear computationally infeasible for the number of image members 12 required for a full size complex display. Approximate solutions are thus determined by numerical method optimization techniques such as genetic algorithms, simulated annealing, and the like.

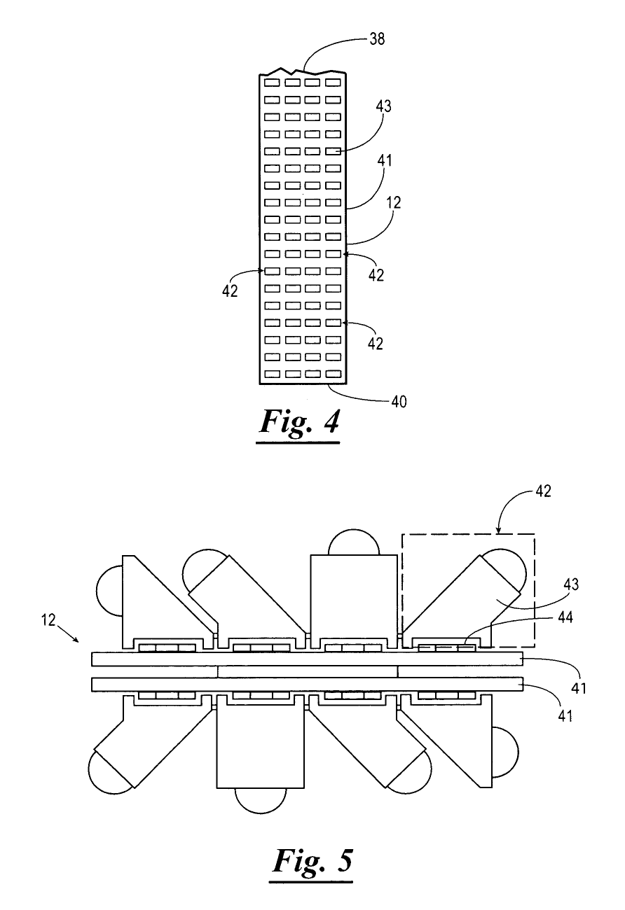

Referring now to FIG. 4 and FIG. 5, the image member 12 includes an image body 41, and a plurality of directional light sources 42. The directional light sources 42 include a directional emitter 43 and one or more light sources 44. The light source 44 of each directional light source 42 on the image body 41, emits light which is optically steered by the directional emitter 43.

In one embodiment, the image member 12 is formed of two substantially identical image bodies 41 placed adjacent to each other. One such image member 12 is depicted in FIG. 5 in which two substantially identical image bodies 41 are placed in a back-to-back configuration forming the single image member 12. This configuration supports at least a two-directional capability. It should be understood that additional configurations such as four-directional and eight-directional capabilities may be supported with the inclusion of additional image bodies 41.

As illustrated in FIG. 5, the directional light source 42 also permits an increase in the number of directions in which light may be emitted. For example, in the embodiment of FIG. 5, the directional light source 42 uses optical steering through the use of a directional emitter 43 overlaying the light source 44 to focus and direct light thus increasing the number of directions. The directional emitter 43 of FIG. 5 supports eight varying directions, however, the number of directions may be vary with the selection of light sources 44 and/or directional emitters 43. Further, it should be understood that the directional light source 42 may use other methods of optical steering such as, for example, the use of diffraction gratings either with or without collimating lens.

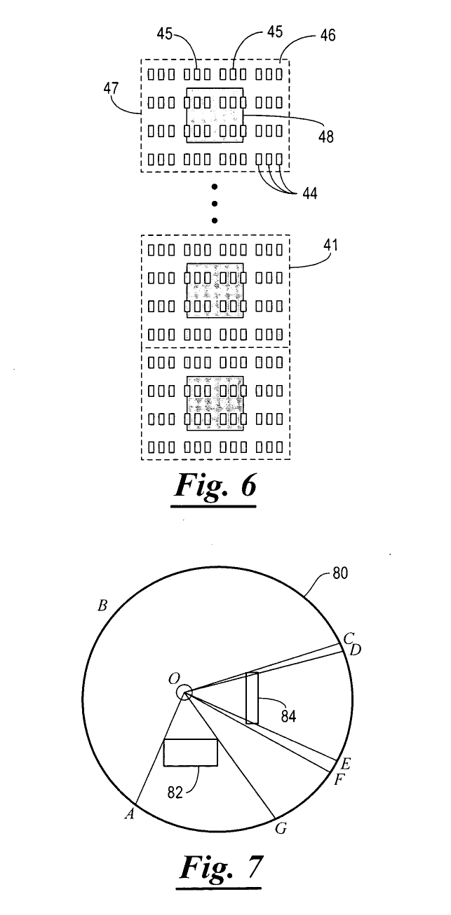

The light source 44 may include LED, LCD, OLED, PLED, plasma, TFT LCDs, TFT OLEDs, or any other device suitable for creating image representations. Further the light source 44 includes a plurality of lights 45 cooperating to provide multiple dimensions of variability (such as for example red, green, and blue or cyan, magenta, and yellow). FIG. 5 and FIG. 6 demonstrate light sources 44 as having multiple dimensions of variability in that the light source is a matrix of red, green, and blue LEDs 45. The combination of one red LED, one green LED, and one blue LED is considered a single light source 44. Adjusting the apparent relative brightness of the individual red LED, green LED, and/or blue LED will provide a multitude of colors and shades. The use of the RGB color space is only intended as an example and as such other color spaces are contemplated and would be sufficient in providing image representations.

To simplify positioning and transmission of data, each directional light source 42 is further grouped into clusters 47 with each cluster 47 controlled by an integrated circuit 48 which allows the routing of signals to be short and localized. The embodiment of FIG. 6 demonstrates such an arrangement where the cluster 47 comprising sixteen individual directional light sources 42 controlled by the integrated circuit 48 placed on a back side of a PCB 46.

However, it should be understood that other methods of transmitting data to the directional light source 42 or the individual light sources 44 is contemplated and may not require the use of cluster formations.

Referring again to FIG. 1, the movement device 14 sweeps the image members 12 about the space within the enclosure 22. In one embodiment, the movement device 14 includes a motor 50 driving a linkage 54 operatively connected to the rod 36 thereby providing rotational movement to the image generation device 11, and thus the image members 12 thereof. The linkage 54 is depicted in FIG. 1 as having two pulleys 55a and 55b as well as a belt 55c. However, it should be understood that other manners of driving the image generation device 11 via the movement device 14 is contemplated. For example, the movement device 14 can include one or more mechanical, electrical, pneumatic, or magnetic components for driving the image generation device 11. For example, the movement device 14 can include a pneumatic rotor driven by an air supply.

The image controller 16, in general, receives a signal indicative of an image from a plug 58 preferably connected to the enclosure 22, stores the image in a memory typically to the image controller 16, and then provides signals to the image members 12 of the image generation device 11 (and possibly other parts thereof, such as the supports 13a and 13b) thereby generating the image of the swept volume display 10. As will be understood by one skilled in the art, the image controller 16 is typically provided with a processing unit 62, a first communication link 64, extending between the plug 58 and the processing unit 62, and a second communication link 66 extending between the processing unit 62 and the image members 12 of the image generation device 11.

In the embodiment depicted in FIG. 1, the first communication link 64 is implemented as a cable, and the second communication link 66 is implemented as a cable and a mechanical assembly, such as slip rings for providing the signals to the image members 12. However, it should be understood that the first communication link 64 and the second communication link 66 can be implemented in a variety of manners, such as slip ring, inductive coupling, optical linkage, radio frequency, and combinations thereof.

Further, it should be understood that the first communication link 64 and/or the second communication link 66 can be constructed of one or more conductive elements. For example, the first communication link 64 can be a coaxial cable, and the second communication link 66 can be a variety of separate conductive elements.

It should be understood that the processing unit 62 can be provided as a single component or multiple components depending upon the specific implementation desired. In addition, the processing unit 62 can be any type of electronic or optical device capable of receiving the signal indicative of the image, storing the image, and providing signals to at least the image members 12 as discussed above. For example, the processing unit 62 can include a microprocessor, a digital signal processor, a microcontroller, or combinations thereof. As discussed above, the processing unit 62 can be distributed into multiple separate devices.

As depicted in FIG. 1, the processing unit 62 is provided with a first processing unit 62a and a second processing unit 62b. The processing unit 62a is designed to connect to an exterior computer via the first communication link 64 and the plug 58, and receive signals indicative of the image. The first processing unit 62a then stores the image and provides signals to the processing unit 62b indicative of the image. The processing unit 62b decodes the signals indicative of the image and provides the decoded signals to the image members 12. Thus, the processing unit 62a is typically provided stationary within the enclosure 22, while the processing unit 62b moves with the image generation device 11. In one preferred embodiment, the processing unit 62b is mounted to one of the supports 13, such as the support 13b.

As previously discussed, image members 41 contain a plurality of integrated circuits 48 wherein each integrated circuit contains sufficient memory data to control each cluster 47 of lights sources 42. Together these integrated circuits 48 are capable of rendering all of the synchronized image elements for a complete 360 degree sweep of the display under the control of a master clock signal. Rotation can be achieved by delaying or advancing the synchronization pulse(s) by a user controlled amount to realize a natural overall rotation, clockwise or counterclockwise, of the entire image. This image rotation speed can be controlled by the user via a hardware interface or an external software command via the processing units 62a and 62b. The distributed image memory can be updated or altered via processing units 62a and 62b to provide image change or motion within the display.

In general, the synchronization controller 18 serves to synchronize the image generation device 11 with the image controller 16 so that the images produced by the image generation device 11 are stable, or move at a preselected or predetermined rate. However, it is contemplated, the synchronization controller 18 may be incorporated into the image controller 16 and need not be a separate device.

The synchronization controller 18 is provided with a position sensor 70, and a processing unit 74. The position sensor 70 is adapted to determine the position of the image members 12 in real-time so that the processing unit 74 can synchronize the movement of the image generation device 11 with the image controller 16.

In the embodiment depicted in FIG. 1, a position sensor 70 is mounted to the enclosure 22 and extends past a portion of the support 13a. However, it should be understood that the position sensor 70 does not necessarily have to overlap past any portion of the support 13a. For example, the position sensor 70 could be positioned directly adjacent to the support 13a. Further, although in the example depicted in FIG. 1 the position sensor 70 is positioned adjacent to and/or overlaps the support of 13a, it should be understood that position sensor 70 could be positioned adjacent to and/or overlapping the support 13b, or combinations thereof. For example, the synchronization controller 18 could be provided with multiple position sensors 70 with some of the position sensors 70 positioned adjacent to the support 13a, while others of the position sensors 70 are positioned adjacent to the support 13b. Further, it should be understood that the synchronization controller 18 could be provided with multiple position sensors positioned only adjacent to the support 13a, or the support 13b. Additionally, through the use of devices such as retroreflectors, the position sensors 70 can be placed in a multitude of other positions dependent upon the intended use.

In one embodiment, the position sensor 70 is an optical sensor having a transmitter positioned on one side of the support 13a, and a receiver positioned on an opposite side of the support 13b whereby the support 13 extends in between the transmitter and receiver of the position sensor 70. The support 13 be can be provided with a hole opening so as to permit optical signals generated by the transmitter to pass past the support 13b and thereby be received by the receiver of the position sensor 70. Although in the example depicted, the position sensor 70 is an optical position sensor, it should be understood that the position sensor 70 could be implemented in other manners, such as an electromagnetic sensor, a mechanical sensor, an electrical sensor, or other type of similar device. Further, it should be understood that instead of having the support 13 be constructed of a solid material having an opening there through, the support 13b could have an outwardly extending tab which intermittently breaks the transmission of light, and/or another medium, such as ultrasonic signals, pneumatic signals, or the like between a transmitter and/or receiver of the position sensor 70.

Further, it should be understood that the position sensor 70 can determine the position of the image members 12 and/or the image generation device 11 indirectly. That is, the position sensor 70 can be adapted to determine the position of an element which is related to the image member 12, and/or the image generation device 11 without such device being a part of the image member 12 and/or the image generation device 11. For example, the position sensor 70 can be a motor sensor which determines the position of a shaft of a motor driving the image generation device, and thereby extrapolate from the position of the motor, and/or the shaft the position of the image members 12, and/or the image generation device 11.

In any event, signals indicative of the position of the image members 12, and/or the human image generation device 11 are provided to the processing unit 74 which determines such position and by using any one or a variety of factors, such as the speed of rotation of the support 13b, the time between position signals, or the like.

The processing unit 74 can be constructed of any device capable of receiving the signals from the one or more position sensor 70 and determining the position of the image members 12 and providing synchronization signals to the movement device 14, and/or the image controller 16. For example, the processing unit 74 can be one or more microprocessors, one or more digital signal processors, and/or one or more microcontrollers or the like. Further, although the processing unit 74 is shown as a unitary device, it should be understood that the processing unit 74 can be distributed if desired.

The power supply 21 includes a power supply circuit which receives power from a power generation device and supplies the power to the various parts of the swept volume display 10, such as the image members 12, the movement device 14, the image controller 16, and the synchronization controller 18. The power supply 21 can provide the power to such components in any suitable manner, such as slip rings, inductive coupling, conductive elements, or the like. The power generation device of the power supply 21 can be any suitable power generation device, such as commercial electrical power, a solar cell, a battery, portable generation, or the like.

FIG. 7 depicts a top plan view of a hypothetical three-dimensional scene produced using the swept volume display 10. The outer circle 80 represents the edge of the display. Without the loss of generality, light is considered to be emanating from point O. In the regions ABC and FG, a viewer on the outside boundary 80 would have a clear view of point O thus light is emitting at its normal brightness towards these regions. In region GA, an opaque object 82 in the scene would theoretically block the view of point O, therefore no light should be emitted from point O towards this region. Finally, in region CF a semi-transparent object 84 would theoretically partially obscure the view of point O. Thus, the brightness of the light from point O emitted towards this region is reduced simulating the attenuation an actual semi-transparent object would create. Depending on application, the variations in the thickness of the semi-transparent object 84 along the path could be taken into account (for more realism) or simplified to consider the brightness towards region DE as constant and towards regions CD and EF as linearly ramping (to reduce computational requirements).

To make the swept volume display 10, the image generation device 11 is provided and then connected to the rods 34 and 36. Then, the image generation device 11 having the rods 34 and 36 connected thereto is positioned within the enclosure 22 and secured to the enclosure 22 as shown in FIG. 1. The movement device 14 is then connected to the image generation device 11, such as by using the linkage 54. The image controller 16 and the synchronization controller 18 are installed within the enclosure 22 and operably connected to the image members 12 of the image generation device 11 so that the image controller 16 communicates with and/or controls and/or supply signals to the image members 12. The synchronization controller 18 supplies signals to the image controller 16, or the movement device 14 so as to synchronize the image controller 16 with the movement device 14.

To use the swept volume display 10, a user supplies power to the swept volume display 10 utilizing the power supply 21. Image data can be stored in memory located with the processing unit 62a or can be loaded via an external communication interface. The processing unit 62a transfers image data to the processing unit 62b across slip ring contacts or across contactless inductive, radio frequency, or optical communication link to the processing unit 62b. The processing unit 62b distributes the image data for storage into the memory of the integrated circuits 48. Rotational sensor signals from the processing unit 62b enable the integrated circuit 48 to render the image in any rotational position required or continuously rotate the image at a user selected speed, clockwise or counterclockwise, with no image update necessary. Additional user controls for image manipulation using joysticks, buttons, an/or switches can be incorporated and control image updating, non-rotational movements or image translation into a new image. Image manipulation can affect image modification through the processing unit 62a or through external computer software control to produce partial or total image updates.

From the above description it is clear that the embodiments are well adapted to carry out the objects and to attain the advantages mentioned herein as well as those inherent. While presently preferred embodiments have been described for purposes of this disclosure, it will be understood that numerous changes may be made which will readily suggest themselves to those skilled in the art and which are accomplished within the spirit of the embodiments disclosed and as defined in the appended claims.

1. A swept volume display for displaying an image, comprising:
at least two image members, at least one of the image members having a directional light source comprising:
a directional emitter; and
a light source having a plurality of lights cooperating to direct light through the directional emitter;
a movement device sweeping the image members; and
an image controller receiving a signal indicative of an image, storing the image, and providing signals to the image members.

2. The swept volume display of claim 1, further comprising a sensor producing signals indicative of the location of the image members, and a synchronization controller receiving the signals from the sensor and synchronizing the controller.

3. The swept volume display of claim 1, further comprising one or more position sensors for determining the positioning of the image members in real-time.

4. The swept volume display of claim 1, further comprising an enclosure defining an internal space wherein the image members are positioned within the internal space of the enclosure.

5. The swept volume display of claim 4, wherein the movement device and the image controller are positioned within the internal space of the enclosure, the enclosure having positioned adjacent to the movement device and the image controller an opaque area.

6. The swept volume display of claim 1, wherein the light source includes a plurality of lights providing multiple dimensions of variability.

7. The swept volume display of claim 6, wherein the light source is a matrix of red, green, and blue LEDs wherein adjusting the brightness of the individual LEDs provides a multitude of colors and shades in the image.

8. The swept volume display of claim 1, further comprising a motor driving a linkage to sweep the image members.

9. The swept volume display of claim 1, further comprising a processing unit, a first communication link, and a second communication link wherein the processing unit receives the signal from the first communication link, stores the image, decodes the image, and provides a decoded signal to the image members via the second communication link.

10. A swept volume display for displaying an image, comprising:
an image generation device having a longitudinal axis, the image generation device comprising:
a plurality of image members directing light in at least one direction, at least two of the image members equidistant from the longitudinal axis; and
at least one support connected to the image members for stabilizing the image members while the image members are being swept;
a movement device sweeping the image members; and
an image controller receiving a signal indicative of an image, storing the image, and providing signals to the image members to cause the image members to cooperate and display the image.

11. The swept volume display of claim 10, wherein the image members are connected to the support so as to maintain a constant distance from the longitudinal axis.

12. The swept volume display of claim 10, wherein each image member is placed on the support so as to substantially block the view of light emitted from other image members.

13. The swept volume display of claim 10, further comprising an enclosure having one or more opaque areas and defining an internal space and wherein the image generation device, the movement device, and the image controller are positioned within the internal space.

14. The swept volume display of claim 13, further comprising one or more rods positioned between the enclosure and the support for rotating the image generation device about an axis.

15. The swept volume display of claim 10, further comprising a power supply for supplying power to the movement device and the image controller.

16. A method of using a swept volume display for displaying an image, comprising:
providing a swept volume display comprising at least two image members, a movement device, an image controller, and a power supply, at least one image member including a directional light source comprising a directional emitter and a light source having a plurality of lights cooperating to direct light through the directional emitter;
supplying power to the swept volume display.

17. The method of claim 16 further comprising the step of loading image data to the image controller.

18. The method of claim 16 further comprising the step of manipulating the image.

19. A method of making a swept volume display, comprising:
providing an image generation device, the image generation device comprising at least two image members, at least one image member including a directional light source comprising a directional emitter and a light source having a plurality of lights cooperating to direct light through the directional emitter;
connecting a movement device to the image generation device;
connecting an image controller to the image generation device such that the image controller communicates with the image generation device.

20. The method of claim 19 further comprising the step of connecting a synchronization controller to the image controller and image generation device such that the synchronization controller communicates with the image generation device and the image controller.

21. The method of claim 19 further comprising the step of positioning the image generation device within an enclosure.

22. The method of claim 19 further comprising the step of connecting the image generation device to a rod.

23. The method of claim 22 further comprising the step of positioning the image generation device within an enclosure by connecting the rod to the enclosure.

24. The method of claim 19 further comprising the step of connecting the image controller to the movement device such that the image controller communicates with the movement device.
